(19) United States
(12) Patent Application Publication
(10) Pub. No.: US 2024/0141515 A1
(43) Pub. Date: May 2, 2024

(54) NOVEL LEAKS CONTAINER FOR ELECTROCHEMICAL STACK

(71) Applicants: ANGELO D'ANZI, Medicina (IT); Giovanni Cufalo, Palermo (IT)

(72) Inventors: ANGELO D'ANZI, Medicina (IT); Giovanni Cufalo, Palermo (IT)

(21) Appl. No.: 18/232,295

(22) Filed: Aug. 9, 2023

Related U.S. Application Data
(60) Provisional application No. 63/396,562, filed on Aug. 9, 2022.

(51) Int. Cl. C25B 9/60; C25B 1/04; C25B 9/05; H01M 8/0656

(52) U.S. Cl. CPC C25B 9/60; C25B 1/04; C25B 9/05; H01M 8/0656

(57) ABSTRACT

An electrochemical device which is a novel leaks container for an electrochemical stack, is suitable for working at high absolute pressures. The only parts designed to work at high pressures are the end heads and the leak container. The internal part, the active part, where the reactions using or producing gas take place is designed to operate at low relative pressures. In this way it is possible to build electrolyzers or fuel cells that work at high pressures without the active part of the same being designed for such high pressures.

### CROSS REFERENCE TO RELATED APPLICATIONS

This application claims the priority of Provisional Application No. 63/396,562 filed on Aug. 9, 2022, inventors Angelo D′Anzi and Giovanni Cufalo, entitled “NOVEL LEAKS CONTAINER FOR ELECTROCHEMICAL STACK”. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to an electrochemical device suitable for working at high absolute pressures thanks to a container-shell able to withstanding very high pressure. The invention relates to an electrochemical device comprising a leaks container. More specifically, the invention described herein involves all devices and systems in which are produced or used reactive gas and in particular hydrogen.

### BACKGROUND OF THE INVENTION

Hydrogen is a common gas that has many industrial uses, such as petroleum refining, metal treatment, food processing and ammonia production. The combustibility of hydrogen in air makes hydrogen difficult to store and ship. For this reason, it is generally not advisable to produce hydrogen on a large-scale production in a centralized facility for subsequent distribution across large geographical regions. Hydrogen is used near the site of its production.

A hydrogen supply is more advisable for a hydrogen refueling system and for the operation of fuel cells. The fact that hydrogen is a highly abundant element leads to the presumption that it is relatively simple to provide. The most conventional industrial processes of producing hydrogen include coal extraction, oil pyrolysis and catalytic “steam reforming”. These methods provide for the final steps of elimination of the residual carbon dioxide and carbon monoxide. Carbon sequestration can be applied to reduce carbon oxides emissions but the efficiency of this approach is not satisfying.

Water electrolysis is an alternative method of producing hydrogen gas, it is eco-friendly and can become cost effective also if energy is required to produce hydrogen from water. Water electrolysis is made inside a water electrolyzer that is an electrochemical device used to split water molecules into hydrogen and oxygen by passage of an electrical current.

Water electrolysis has attracted considerable attention due to its inherent advantages of producing relatively pure hydrogen, flexibility for small and large-scale production, and sustainability when the electricity used in the electrolysis comes from renewable sources.

The production of hydrogen by water electrolysis occurs at relatively low pressures. To increase the production pressure, the stack must be designed with materials suitable for high pressures and often uncommon and very expensive.

The pressurization of hydrogen to the pressure values required by different end-users is conventionally done by a mechanical compressor which has high construction costs, high maintenance costs, poor reliability and is noisy.

Pressurizing the hydrogen internally in the electrolyzer stack is an attractive option.

Improving the performance of the electrolyzer stack in one dimension usually results in reduced performance in other parameters (efficiency, cost, durability, mechanical strength and production). This leads to trade-offs to be addressed through innovation in materials and manufacturing. Potential breakthroughs and inventions in technology development can be disruptive in terms of accelerating cost reductions for the stack, while plant balance is more economies of scale, standardization of design and supply chains.

### DESCRIPTION OF THE RELATED ART

FIG. 3 shows an electrochemical stack for the use or production of hydrogen comprising a plurality of bipolar cells, a first one of the plurality of bipolar cells being indicated by the numeral 1 in FIG. 3. Each bipolar cell 1 has two faces with different polarity: one anodic and the other one cathodic. Each face is composed of an electrically conductive element on which the gases flow, called an electrodic plate or plate, and an electrode. The two electrodes are separated by a porous septum, usually a diaphragm or membrane. The bipolar cells. the active part of stack, are sandwiched by two end plates, called also end heads, of which one is an anode terminal 2 and the other one is a cathode terminal 3.

If the plates are to be electrically insulated towards the outside, these are individually mounted on non-conductive elements having openings for the flow of the reaction fluids. When the bipolar cells are stacked together, the openings form hollow channels for reagent distribution and product collection. The end plates also include openings positioned at the axis of the bipolar cell openings.

The end plates and the electrode plates must be made of any material that offers the required electrical-mechanical properties and corrosion resistance against both acidic and basic aggressive environments.

During operation, the pressure inside the stack increases due to the passage of fluids and to the reactions using and producing gas. Increased pressure leads to complications in stack design and the use of materials suitable for the new more high pressure level.

The higher operating pressure can give rise to leaks towards the outside which can cause various drawbacks. Gas leaks to the outside give rise to dangerous situations. Hydrogen leaks can create a potentially explosive area.

Any potential leaks of hydrogen must be checked and can lead to shutdowns of systems using or generating hydrogen. Leaks and plant shutdowns cause drawbacks that can only be solved with the intervention of specialized technicians.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the aim of the present invention is to solve the drawbacks described above by providing a containment for the stack that can be pressurized.

The containment will be filled with an inert gas or inert liquids and then be put under pressure. This will give the possibility to design stacks that operate using or producing gas at higher pressures without themselves being designed to work at those pressures. In fact, the operating pressure of the stack is the relative pressure which depends on the pressure of the inert gas present in the volume between the containment and the stack. In this way, systems working at high pressures but with stacks operating at relatively low pressures can be designed. These stacks can also be built with more common materials and, therefore, less expensive.

The presence of the containment in the stack filled with a pressurized gas or liquids also limits the leaks of the reagent gases from the stack to the outside because these leaks can be intercepted in the volume between the container and the stack before they go outwards.

The leaks of the stack will be diluted by the inert gas. Therefore, the external leaks of gases such as pure hydrogen will be very reduced, avoiding dangerous situations and potentially explosive areas.

In some embodiment of this invention, the container can be pressurized at pressures higher than those the operating pressure of the stack.

The presence of the containment under pressure with an inert gas or liquids at a pressure level higher than that of the stack can, however, give rise to infiltrations of the inert gas in the stack. These infiltrations can cause a reduction in the performance of the stack in terms of both production and quality. These performance reductions will however be immediately detected because the performances are always monitored by the detection systems already installed by default.

Other objects and advantages of the present invention will be more readily apparent from the following detailed description when read in conjunction with the accompanying drawings.

### BRIEF DESCRIPTION OF THE DRAWINGS

FIG. 1A is a perspective view of a novel leaks container for an electrochemical stack according to the present invention, showing the novel leaks container viewed from the front right and from above.

FIG. 1B is a perspective view of a novel leaks container for an electrochemical stack according to the present invention, showing the novel leaks container viewed from the rear right and above.

FIG. 2A is an exploded perspective view of the novel leaks container of FIG. 1A and FIG. 1B, as viewed from the front right and above.

FIG. 2B is an exploded perspective view of the novel leaks container of FIG. 1A and FIG. 1B, as viewed from the rear right and above.

FIG. 3 is an exploded perspective view of a related art device having an electrochemical stack for the use or production of hydrogen comprising a plurality of bipolar cells, as viewed from the front right and above.

FIG. 4 is a partially assembled view of the novel leaks container of FIG. 1A, FIG. 1B, FIG. 2A, and FIG. 2B, as viewed from the front right and above, and showing a region referred to as a free volume.

### DETAILED DESCRIPTION OF THE INVENTION

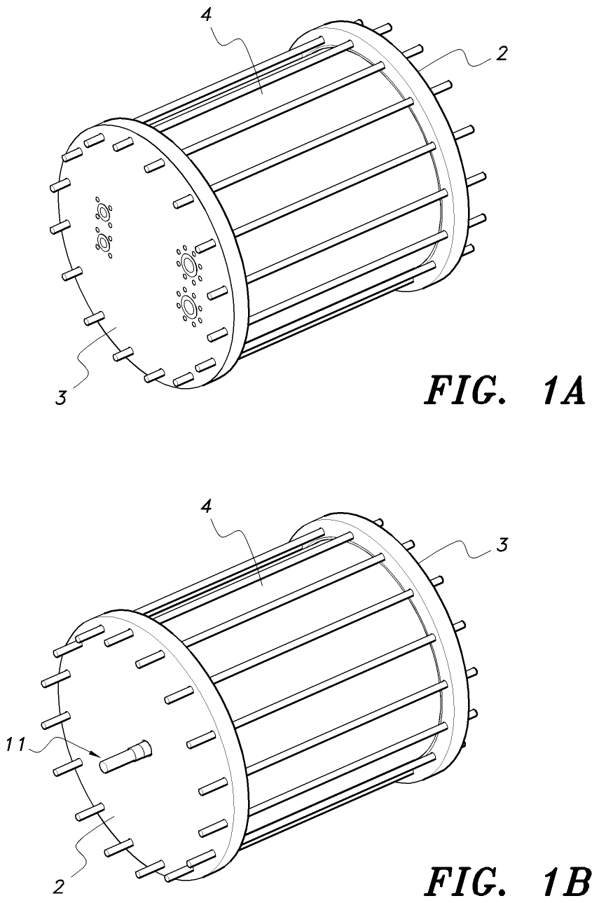

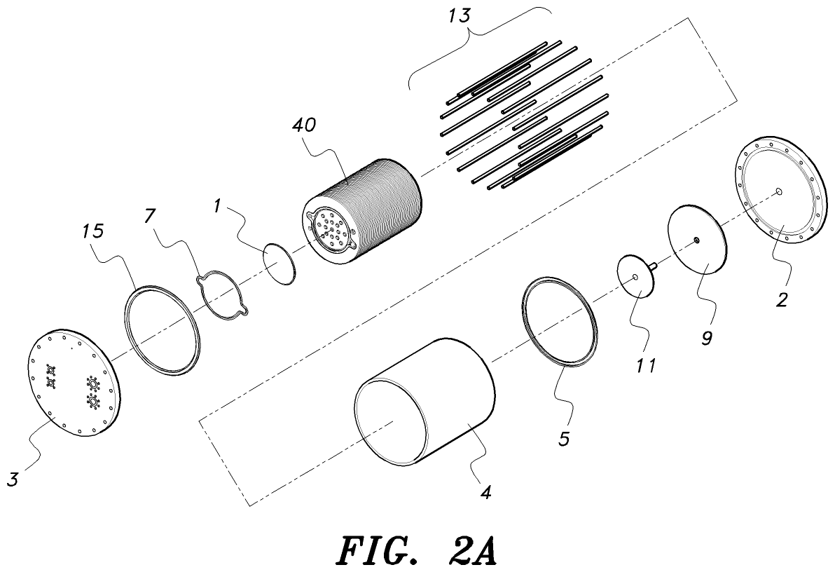

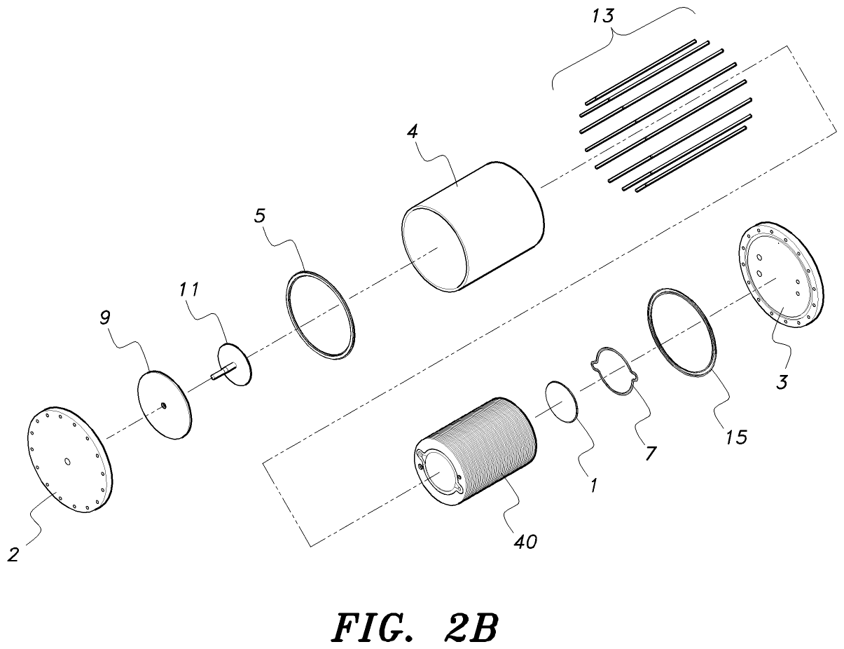

FIG. 1A is a perspective view of a novel leaks container for an electrochemical stack according to the present invention, showing the novel leaks container viewed from the front right and from above. The novel leaks container includes an anodic terminal head 2 which is also an end plate, a cathodic terminal head 3 which is another end plate, and a container member 4, these elements together forming a container for containing an electrochemical stack (not shown in FIG. 1; shown in FIG. 2A and FIG. 2B). The container is designed and constructed to withstand high pressures.

FIG. 1B is a perspective view of a novel leaks container for an electrochemical stack according to the present invention, showing the novel leaks container viewed from the rear right and above. The novel leaks container includes the anodic terminal head 2, the cathodic terminal head 3, and the container member 4, these elements together forming the above-noted container for containing an electrochemical stack (not shown in FIG. 1; shown in FIG. 2A and FIG. 2B).

FIG. 1B further shows an anodic current connector 11. The internal part of the electrochemical stack included in the container described hereinabove remains formally identical to the standard realization of the related art described hereinabove.

However, according to preferred embodiment of this invention the internal part of the stack can be built considering that it will operate at relatively low pressures allowing the use of common and inexpensive materials.

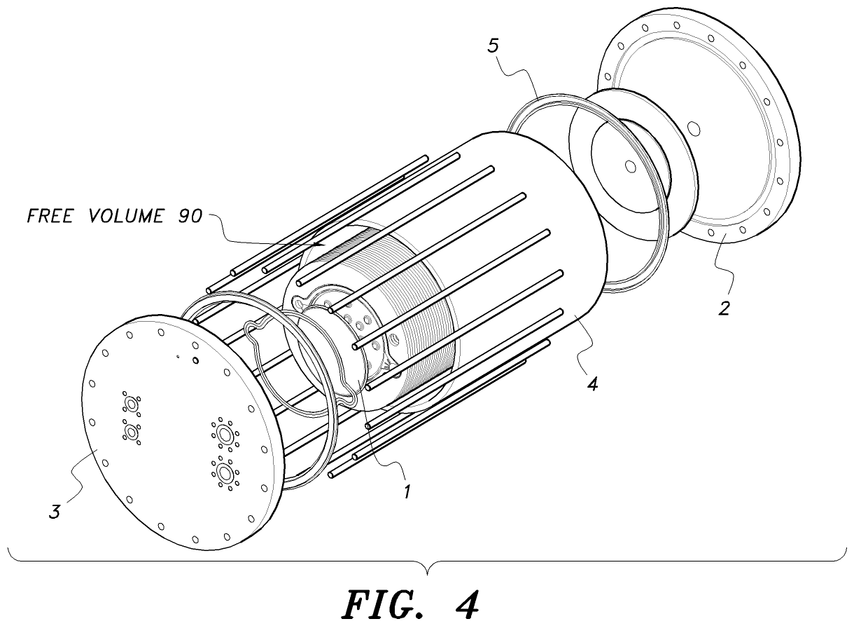

According to another embodiment of this invention, the end plates 2 and 3 are designed in such a way as to also include a free volume (shown in FIG. 4) existing between the electrochemical stack and the container member 4, the free volume space containing an inert gas or inert liquids.

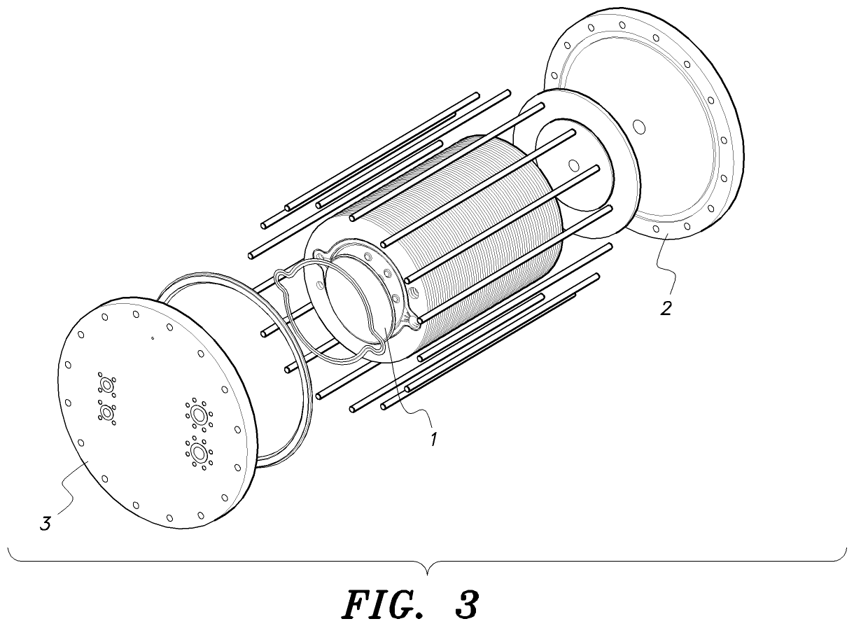

The part of the end plates 2 and 3 intended for threaded rods 13 (shown in FIG. 2A and FIG. 2B) remains identical to the related art discussed above (shown in FIG. 3).

In accordance with another embodiment of this invention, the container does not in any case have to electrically connect the two end plates 2 and 3. The end plates 2 and 3 are designed and constructed by providing a housing for a gasket 5 (FIG. 2A) that can guarantee the assembly of the container, the electrical insulation of the same and the hydraulic seal in the coupling between the container and the end plates 2 and 3 (also referred to as end heads 2 and 3) to avoid any leaks of fluid outward of the container described hereinabove.

In another preferred an embodiment of this invention, the free volume 90 of FIG. 4, disposed between the container element 4 and the active part of the electrochemical stack is filled with an electrically non-conductive and inert fluid which must be pressurized. The pressure of this fluid is preferably constantly monitored to ensure that the internal part of the stack works at relatively low pressures.

According to another embodiment of this invention, the differential pressure between the fluids entering or leaving the electrochemical stack and the fluid contained in the free volume 90 (FIG. 4) between the container element 4 and the active part of the electrochemical stack must be constantly controlled: control of this pressure is also used to quickly identify any gas leaks from the active part of the electrochemical stack.

According to another embodiment of this invention, controlling the pressure of the fluid present in the free volume 90, as above identified, can be used to fairly quickly identify any gas leaks towards the outside.

According to another embodiment of the present invention, the inert gas contained in the free volume 90 as above identified can be used for safety reasons. In this case, the stack will be built by adding a pipe and a normally closed valve to the construction to put in communication the free volume 90, as identified above, with the active part of the electrochemical stack. In the event that an emergency shutdown of the stack occurs, the stack will start to release the reagent gases and immediately after the normally closed valve will open, putting the aforementioned free volume 90 in communication with the active part of the stack which will thus be inert. This will make it possible for the stack to go into a safe state without the help of other external equipment.

FIG. 2A is an exploded perspective view of the novel leaks container of FIG. 1A and FIG. 1B, as viewed from the front right and above. The elements shown include the cathodic terminal head 3, a tightening seal shell 15 (which is a gasket), a seal 7, a cathode 1, an electrochemical stack 40, a plurality of tie rods 13, the container member 4, a sealing ring 5, the anodic current connector 11, an insulating anodic plate 9, and the anodic terminal head 2.

FIG. 2B is an exploded perspective view of the novel leaks container of FIG. 1A and FIG. 1B, as viewed from the rear right and above. The like numerals represent like elements of FIG. 2A.

FIG. 3 is an exploded perspective view of a related art device which is discussed above, having an electrochemical stack for the use or production of hydrogen comprising a plurality of bipolar cells, as viewed from the front right and above. The like elements of FIG. 2A are likewise numbered in FIG. 3.

FIG. 4 is a partially assembled view of the novel leaks container of FIG. 1A, FIG. 1B, FIG. 2A, and FIG. 2B, as viewed from the front right and above, and showing a region referred to as a free volume 90. All of the elements are as discussed hereinabove, with like numerals representing like elements as discussed in FIG. 2A.

The invention being thus described, it will be evident that the same may be varied in many ways by any one having skill in the applicable arts. Such variations are not to be regarded as a departure from the spirit and scope of the invention and all such modifications are intended to be included within the scope of the claims.

What is claimed is:

1. An electrochemical stack suitable for working, using or producing gas at high absolute pressures comprising: two end heads and a container member together forming a container suitable for resisting high pressures and an internal part of the stack, where the reactions using or producing gas take place.

2. An electrochemical stack according to claim 1, wherein said stack has an inner part and an outer part, wherein the inner part of the stack is designed to operate at low relative working pressures.

3. An electrochemical stack according to claim 1, wherein said two end heads are designed and built with the space necessary to ensure the assembly of the container.

4. An electrochemical stack in accordance with claim 1, wherein said two end heads comprise the housing of an insulating gasket which is needed to ensure leak-tight assembly of the container, the electrical insulation of the container, and a hydraulic seal in the coupling between the container and the end heads to avoid fluid leaks outwards.

5. An electrochemical stack according to claim 1, wherein a free volume exists between the container and an active part of the stack, said free volume is filled with an inert fluid which is compressed at high pressure to make the active part of the stack work at relatively low operating pressures.

6. An electrochemical stack according to claim 5, wherein controlling the pressure of the fluid present in the free volume, it is possible to identify gas leaks from the inner part of stack or towards the outside of the container.

7. An electrochemical stack according to claim 1, wherein the stack is formed by adding a pipe and a normally closed valve to the construction to put in communication with the free volume, with the active part of the stack.

8. An electrochemical stack according to claim 1, wherein said container is intrinsically safe.

9. An electrochemical stack suitable for working, using or producing gas at high absolute pressures comprising: two end heads and a container member together forming a container suitable for resisting high pressures and an internal part of the stack, where the reactions using or producing gas take place.
